(19) United States
(12) Patent Application Publication
(10) Pub. No.: US 2007/0257067 A1
(43) Pub. Date: Nov. 8, 2007

(54) Fluid dispenser head, a dispenser including such a head, and a method of manufacturing such a head

(75) Inventors: Alexandra Parmentier, La Harengere (FR); Sebastien Michaux, Elbeuf (FR)

Correspondence Address: SUGHRUE MION, PLLC, 2100 PENNSYLVANIA AVENUE, N.W., SUITE 800, WASHINGTON, DC, 20037, US

(73) Assignee: VALOIS S.A.S

(21) Appl. No.: 11/797,435

(22) Filed: May 3, 2007

Related U.S. Application Data
(60) Provisional application No. 60/834,802, filed on Aug. 2, 2006.

(30) Foreign Application Priority Data
May 4, 2006 (FR) FR-06/51592

(51) Int. Cl. B67D 3/00; F16K 7/04

(52) U.S. Cl. 222/507; 222/528; 251/4; 222/402.1; 222/321.9

(57) ABSTRACT

A fluid dispenser head for mounting on an outlet from a fluid dispenser member such as a pump or a valve, the head comprising:

an endpiece (1) that is adapted to be mounted on the outlet from the dispenser member;

a fluid dispenser nozzle (2) through which the fluid leaves the head; and

a flexible hose (3) connecting the endpiece (1) to the nozzle (2);

the hose being injection-molded on the endpiece (1) and/or on the nozzle (2).

### CROSS REFERENCE TO RELATED APPLICATION

This application claims the benefit under 35 U.S.C. §119(e) of pending U.S. provisional patent application Ser. No. 60/834,802, filed Aug. 2, 2006, and priority under 35 U.S.C. §119(a)-(d) of French patent application No. FR-06.51592, filed May 4, 2006.

### TECHNICAL FIELD

The present invention relates to a fluid dispenser head for mounting on an outlet from a fluid dispenser member such as a pump or a valve. The present invention also relates to a method of manufacturing such a head. The present invention also relates to a fluid dispenser comprising a reservoir, a dispenser member such as a pump or a valve, and a dispenser head of the invention. Preferred, but non-exclusive, fields of application of the present invention are perfumery, cosmetics, and pharmacy.

### BACKGROUND OF THE INVENTION

The head of the present invention is a particular type comprising an endpiece for mounting on, or associating with, the outlet from a pump or a valve, a dispenser nozzle through which the fluid leaves the head, and a flexible hose connecting the endpiece to the nozzle, and serving to feed fluid from the endpiece to the nozzle. That particular type of dispenser head is used when the nozzle is decoupled from the endpiece, so that the endpiece can be displaced independently of the nozzle. The flexible hose thus provides the decoupled connection between the endpiece and the nozzle.

This type of head is used in particular in fluid dispensers having a dispenser nozzle that is static or stationary, while the pushbutton is axially displaceable down and up. The dispenser nozzle is therefore decoupled from the movable pushbutton. It is also possible to use this type of dispenser head in dispensers that are actuated laterally using hinged actuator means of the “toggle-action” type. Once again, the dispenser nozzle is decoupled from the endpiece that covers the outlet from the pump or the valve. The relative displacement between the nozzle and the endpiece is allowed by the flexible connection hose deforming.

In the past, the flexible hoses of that type of dispenser head have been made from plastics materials that are substantially rigid even though they are deformable. It is necessary for the flexible hose to be rigid enough to enable its two ends to be engaged respectively on the endpiece and on the nozzle. The rigidity of the hose must firstly enable the hose to be held firmly while it is being engaged on the endpiece and the nozzle, and must also guarantee that the hose is securely connected to the endpiece and to the nozzle. With a hose that is too flexible, it is not possible to hold it firmly without the risk of flattening it and of damaging it, and the engagement of the ends is not stable and firm enough to guarantee that the hose is leaktight relative to the endpiece and to the nozzle. That is why flexible connection hoses are always relatively rigid.

However, the relative rigidity of the flexible hose does not always make it possible to decouple the endpiece from the nozzle effectively. In other words, the hose is often too rigid to accommodate the relative displacement between the endpiece and the nozzle.

The relative rigidity of the flexible hose is also a drawback even when the endpiece is not displaceable relative to the nozzle. In some circumstances, the nozzle is situated remote from the endpiece, and the flexible hose must follow a very winding path. In this event, if the flexible hose is too rigid, it cannot be used to connect the endpiece to the nozzle.

### BRIEF SUMMARY OF THE INVENTION

An object of the present invention is thus to remedy the above-mentioned drawbacks of the prior art by defining a flexible hose that is suitable for being used in most endpiece-and-nozzle configurations, regardless of whether or not they are displaceable relative to each other.

To do this, the present invention proposes that the flexible hose is injection-molded on at least one of the endpiece and the nozzle. The flexible hose advantageously includes two connection ends that are injection-molded respectively on the endpiece and on the nozzle. The flexible hose may thus be made of a material selected from the family of thermoplastic elastomers. Injection-molding makes it possible to use plastics materials that are more flexible, and that offer less rigidity. Injection-molding makes it possible to dispense of the rigidity requirements previously required in order to be able to hold the hose, and engage it on the endpiece and/or the nozzle. In addition, by using materials that are more flexible and less rigid, the hose can be completely or almost completely decoupled from the endpiece, while guaranteeing a good supply of fluid. The endpiece and the hose can thus be assembled with configurations and dispositions that would be impossible with a flexible hose that needs to be connected or fitted.

In an advantageous embodiment, the endpiece is movable relative to the nozzle with the flexible hose deforming. The dispenser head may advantageously include actuator means that are engaged both with the endpiece and with the nozzle so as to displace the endpiece relative to the nozzle, the actuator means advantageously forming a nozzle support for receiving the nozzle. The actuator means are advantageously formed integrally with the remainder of the head. The actuator means preferably comprise hinged portions. By way of example, the hinge means can be in the form of a “toggle-action” linkage enabling lateral actuation. The endpiece is therefore not pressed on directly as with a pushbutton, but pressure is applied laterally and the pressure force is transmitted via the hinged portions to the nozzle and to the endpiece. However, it is possible to press directly on the endpiece, or on a part fitted on the endpiece and serving as an axial pushbutton.

The present invention also defines a method of manufacturing a dispenser head as defined above, in which the flexible hose is molded in rectilinear shape by using a rectilinear pin that passes through the endpiece and/or the nozzle. The internal duct formed by the flexible hose is therefore made by the rectilinear pin that is inserted starting from the endpiece or from the nozzle. Once the pin has been unmolded, the flexible hose can be deformed at will.

In another method of manufacturing a dispenser head as described above, the flexible hose is molded in rectilinear shape by using a rectilinear pin that passes through the endpiece and/or the nozzle, and the nozzle is then mounted in its support with the hose deforming. Whereas in the prior art it is necessary to engage both ends of the hose, with the invention it suffices to mount the nozzle on its support without having to worry about connecting the hose. The actuator means are advantageously molded in rectilinear shape, extending substantially perpendicularly to the hose. This makes it easier to mold the head as a single part.

The invention also defines a fluid dispenser comprising: a fluid reservoir; a fluid dispenser member, such as a pump or a valve, defining a body that is mounted in stationary manner on the reservoir, and an actuator rod that is axially displaceable down and up; and a dispenser head as defined above; the endpiece being engaged with the actuator rod, such that the endpiece is secured in displacement with the rod, the nozzle being mounted in stationary manner relative to the reservoir and to the body, the axial displacement of the endpiece causing the injection-molded flexible hose to deform.

### BRIEF DESCRIPTION OF THE DRAWINGS

The invention is described more fully below with reference to the accompanying drawings which show two embodiments of the invention by way of non-limiting example.

In the figures:

FIG. 1 is a vertical section view through the top portion of a dispenser incorporating a dispenser head constituting a first embodiment of the invention;

FIG. 2 is a perspective view of the FIG. 1 dispenser head shown in its state on being unmolded;

FIG. 3 is a vertical section view of the FIG. 2 head at the end of molding;

FIG. 4 is a section view through a dispenser head constituting a second embodiment of the invention shown in its state on being unmolded;

FIG. 5 is a side view of the FIG. 4 dispenser head in its assembled state; and

FIG. 6 is a perspective view of the FIG. 5 dispenser head.

### DETAILED DESCRIPTION

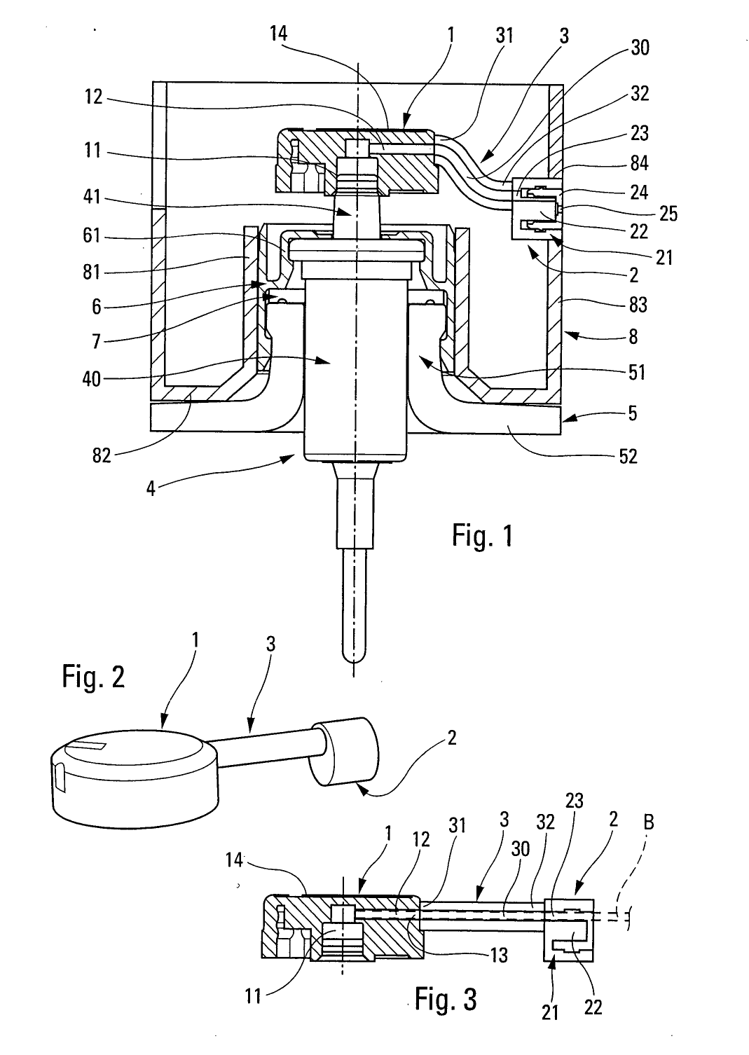

Reference is made firstly to FIGS. 1 to 3 in order to explain in detail the manufacture, the structure, and the functioning of the dispenser head of the first embodiment. In FIGS. 2 and 3, it can be seen that the dispenser head comprises three parts, namely an endpiece 1, a nozzle 2, and a flexible connection hose 3.

The endpiece 1 can be made by injection-molding a plastics material that is relatively or substantially rigid. The endpiece 1 forms a connection sleeve 11 for force fitting on the outlet from a dispenser member, such as a pump or a valve, as described below. The endpiece 1 also includes an internal channel 12 that puts the sleeve 11 into communication with an outlet 13 that is situated on the side in this embodiment. In addition, the endpiece 1 can define a thrust surface 14 on which the user can press by means of one or more fingers, so as to displace the endpiece axially down and up. The endpiece can also be associated with a part that serves as a pushbutton.

In this embodiment, the dispenser nozzle 2 comprises a nozzle-insert holder 21 associated with a nozzle insert 24. The nozzle-insert holder 21 includes an inlet bore 23 that puts the outside into communication with an annular housing that defines a core 22 at its center. The nozzle insert 24 is engaged in the annular housing around the core 22. As visible in FIG. 1, the nozzle insert 24 defines a dispenser orifice 25 that can be a spray orifice. The parts of the nozzle can be made by injection-molding a rigid plastics material.

The flexible hose 3 connects the outlet 13 of the internal channel 12 to the inlet bore 23. The flexible hose 3 defines an internal duct 30 that puts the channel 12 into fluid communication with the bore 23. The flexible hose 3 includes a first end 31 connected to the endpiece 1, and a second end 32 connected to the nozzle 2. In the invention, the two ends 31 and 32 are injection-molded respectively on the endpiece 1 and on the nozzle 2. Thus, the dispenser head can be made as a single part in a single mold. In some circumstances, it is possible for the hose 3 to be injection-molded only on the endpiece 1, or only on the nozzle 2. However, the hose 3 is preferably injection-molded both on the endpiece 1 and on the nozzle 2. As can be seen in FIG. 3, the inlet bore 23, the internal duct 30, and the channel 12 can be made by means of a rectilinear pin B that is inserted starting from the nozzle 2. The pin B can extend as far as the connection sleeve 11 of the endpiece 1. It should be noted that the pin B is rectilinear, so as to be easy to unmold. In the configuration of the endpiece 1 and/or of the nozzle 2, the pin B can be inserted either starting from the endpiece 1, or starting from the nozzle 2. The pin B can be inserted starting from the endpiece 1 when the internal channel 12 extends along the same axis as the sleeve 11. Once the head has been unmolded, it suffices to fit the nozzle insert 24 into the nozzle-insert holder 21. The head can then be put into place, e.g. as shown in FIG. 1. In a variant, it is also possible to envisage that the nozzle does not include a nozzle insert, and that it is thus a single part.

In FIG. 1, the endpiece 1 is mounted on the free end of an actuator rod 41 forming part of a dispenser member 4 that can be a pump or a valve. In conventional manner, the dispenser member 4 comprises a body 40, and an actuator rod 41. The rod 41 defines an internal flow duct (not shown) that opens out at its top end, i.e. in the sleeve 11. The fluid dispensed by the dispenser member thus passes through the endpiece 1, i.e. through the sleeve 11 and the internal channel 12, and then flows along the flexible hose 3, before finally reaching the nozzle 2. In conventional manner, the body 40 of the dispenser member is mounted in stationary manner on the neck 51 of a reservoir 5 by means of a fastener ring 6 that defines a reception housing 61 for the body 40. Furthermore, the ring 6 includes means for becoming fastened on the neck 51. A neck gasket 7 can be used to provide sealing. In addition, the dispenser includes a covering part 8 defining an inner hoop 81, an annular connection flange 82, and an outer casing 83. The hoop 81 becomes engaged around the ring 6 and advantageously blocks it on the neck 51. The connection flange 82 can come to bear against the shoulder 52 of the reservoir 5 from which the neck 51 projects upwards. The outer casing 83 defines an opening 84 in which the nozzle 2 is mounted in stationary manner. Consequently, the nozzle 2 is stationary or static relative to the reservoir 5 and to the body 40 of the dispenser member. In contrast, the nozzle 2 is movable relative to the endpiece 1 that is mounted on the actuator rod 41 that is displaced axially down and up. Thus, by pressing on the bearing surface 14 of the endpiece 1, for example, said endpiece is displaced with the actuator rod 41, thereby causing the flexible hose 3 to deform.

As a result of the flexible hose 3 being injection-molded on the endpiece 1 and on the nozzle 2 (and not fitted between the endpiece 1 and the nozzle 2), it is possible to make it from a plastics material that is far more flexible, and that provides almost complete freedom between the nozzle 2 and the endpiece 1. These two parts are thus completely decoupled. In addition, a difficult operation of engaging the flexible hose 3 with the endpiece 1 and with the nozzle 2, and that requires the use of a relatively rigid flexible hose, is eliminated.

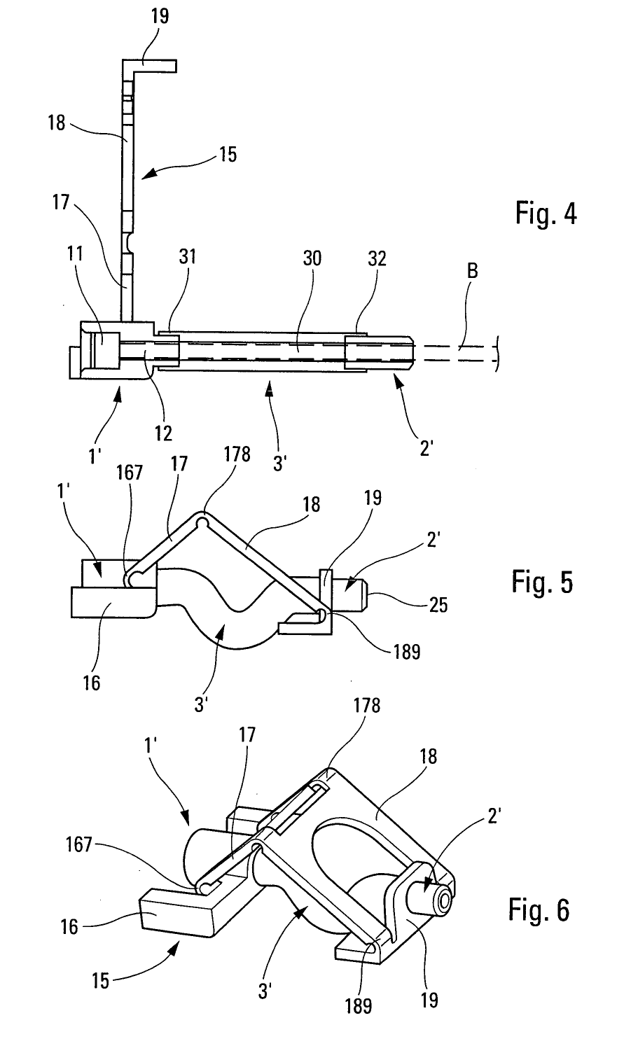

Reference is made below to FIGS. 4 to 6 in order to explain a second embodiment of a dispenser head of the invention.

This dispenser head likewise comprises an endpiece 1′, a nozzle 2′, and a flexible hose 3′ that is injection-molded on the endpiece 1′ and/or on the nozzle 2′. The endpiece 1′ includes a connection sleeve 11 for mounting on the outlet from a dispenser member. The endpiece includes an internal channel 12 that puts the sleeve 11 into communication with the internal duct 30 of the flexible hose 3. The flexible hose includes a first end 31 that is injection-molded on the endpiece 1′, and a second end 32 that is injection-molded on the nozzle 2′. In this embodiment, the nozzle 2′ defines a simple dispenser orifice providing an outlet without the fluid being sprayed. However, it is also possible to imagine that the nozzle 2′ performs spraying. As in the first embodiment, the internal duct 30 and the internal channel 12 can be made by means of a rectilinear pin B that can be inserted starting from the nozzle 2′ or from the endpiece 1′, given that the internal channel 12 extends axially in line with the sleeve 11.

In addition, the dispenser head of the invention also incorporates actuator means 15 that are advantageously made integrally with the endpiece 1′. The actuator means comprise several portions 16, 17, 18, and 19 that are hinged together by hinges 167, 178, and 189. The first portion 16 is integral with the endpiece 1′, as can be seen in FIG. 6. The second portion 17 is connected to the first portion 16 via a first hinge 167. The third portion 18 is hinged to the second portion 17 via a second hinge 178. Finally, the fourth portion 19 is hinged to the third portion 18 via a third hinge 189. The portion 19 serves as a nozzle support for the nozzle 2′, as can be seen in FIGS. 5 and 6. In its state on being unmolded, as shown in FIG. 4, the assembly formed by the endpiece 1′, the nozzle 2′, and the hose 3′ extends substantially perpendicularly relative to the actuator means 15. The flexible hose 30 is then completely rectilinear. To reach the configuration in FIGS. 5 and 6, it is necessary to fold the actuator means 15 at the hinges 167, 178, and 189, and then deform the flexible hose 3 so as to be able to fit the nozzle 2′ in the nozzle support 19. It can thus be observed that the dispenser head of the second embodiment can be made as a single part, incorporating the actuator means 15. The assembly configuration shown in FIGS. 5 and 6 is relatively simple to implement, and it is imposed by the hinges 167, 178, and 189.

The dispenser head in FIGS. 4, 5, and 6 can be used in a laterally-actuated fluid dispenser including, for example, a lateral pushbutton (not shown) that comes to press against the hinge 178. That pressure causes the portions 17 and 18 to be displaced, modifying their relative angle. As a result, the first part 16 is displaced in translation relative to the nozzle support 19. The relative displacement is accompanied by the flexible hose 3′ deforming.

Although the two embodiments in the figures implement endpieces that are displaceable relative to a stationary nozzle, it is also possible to implement the present invention in dispenser heads in which the endpiece is stationary relative to the nozzle, the flexible hose providing a winding connection between the endpiece and the nozzle. It is also possible to imagine that the endpiece is stationary, and the nozzle is movable. It is also possible to envisage that both the endpiece and the nozzle are movable independently of each other. Without going beyond the ambit of the invention, it is also possible to imagine that the endpiece is incorporated in the dispenser member. In this event, the endpiece would not form a connection sleeve.

1. A fluid dispenser head for mounting on an outlet (41) from a fluid dispenser member (4) such as a pump or a valve, the head comprising:
an endpiece (1; 1′) that is adapted to be mounted on the outlet (41) of the dispenser member (4);
a fluid dispenser nozzle (2; 2′) through which the fluid leaves the head; and
a flexible hose (3; 3′) connecting the endpiece (1; 1′) to the nozzle (2; 2′), the fluid being fed from the endpiece to the nozzle through the flexible hose;
the fluid dispenser head being characterized in that the flexible hose (3; 3′) is injection-molded on at least one of the endpiece (1; 1′) and the nozzle (2; 2′).

2. A dispenser head according to claim 1, in which the flexible hose (3; 3′) includes two connection ends (31, 32) that are injection-molded respectively on the endpiece (1; 1′) and on the nozzle (2; 2′).

3. A dispenser head according to claim 1, in which the flexible hose (3; 3′) is made of a material selected from the family of thermoplastic elastomers.

4. A dispenser head according to claim 1, in which the endpiece (1; 1′) is movable relative to the nozzle (2; 2′) with the flexible hose (3; 3′) deforming.

5. A dispenser head according to claim 4, including actuator means (15) that are engaged both with the endpiece (1′) and with the nozzle (2′) so as to displace the endpiece relative to the nozzle, the actuator means (15) advantageously forming a nozzle support (19) for receiving the nozzle (2′).

6. A dispenser head according to claim 5, in which the actuator means (15) are formed integrally with the remainder of the head.

7. A dispenser head according to claim 5, in which the actuator means (15) comprise hinged portions (16, 17, 18, 19).

8. A method of manufacturing a dispenser head according to claim 1, in which the flexible hose (3, 3′) is molded in rectilinear shape by using a rectilinear pin (B) that passes through the endpiece (1; 1′) and/or the nozzle (2; 2′).

9. A method of manufacturing a dispenser head according to claim 5, in which the flexible hose (3′) is molded in rectilinear shape by using a rectilinear pin (B) that passes through the endpiece (1′) and/or the nozzle (2′), and the nozzle (2′) is then mounted in its support (19) with the hose (3′) deforming.

10. A method of manufacturing a dispenser head according to claim 9, in which the actuator means (15) are molded in rectilinear shape, extending substantially perpendicularly to the hose (3′).

11. A fluid dispenser comprising:
a fluid reservoir (5);
a fluid dispenser member (4), such as a pump or a valve, defining a body (40) that is mounted in stationary manner on the reservoir (5), and an actuator rod (41) that is axially displaceable down and up; and
a dispenser head according to any preceding claim 1, the endpiece (1; 1′) being engaged with the actuator rod (41), such that the endpiece is secured in displacement with the rod, the nozzle (2; 2′) being mounted in stationary manner relative to the reservoir (5) and to the body (40), the axial displacement of the endpiece (1; 1′) causing the injection-molded flexible hose (3; 3′) to deform.
